(19) United States
(12) Patent Application Publication
(10) Pub. No.: US 2020/0364100 A1
(43) Pub. Date: Nov. 19, 2020

(54) MEMORY ABSTRACTION FOR LOCK-FREE INTER-PROCESS COMMUNICATION

(71) Applicant: Microsoft Technology Licensing, LLC, Redmond, WA (US)

(72) Inventors: Siddharth Shah, Mountain View, CA (US); Andrew Rodriguez, Palo Alto, CA (US); Andrew J. Carter, Mountain View, CA (US); Scott M. Meyer, Berkeley, CA (US)

(73) Assignee: Microsoft Technology Licensing, LLC, Redmond, WA (US)

(21) Appl. No.: 16/412,160

(22) Filed: May 14, 2019

(51) Int. Cl. G06F 9/54; G06F 3/06; G06F 16/176; G06F 16/901; G06F 12/1009

(52) U.S. Cl. CPC G06F 9/544; G06F 3/0619; G06F 3/064; G06F 3/0659; G06F 3/0673; G06F 2212/657; G06F 16/9014; G06F 16/9024; G06F 12/1009; G06F 2212/1016; G06F 16/1767

(57) ABSTRACT

The disclosed embodiments provide a system for managing inter-process communication. During operation, the system executes a block storage manager for managing shared memory that is accessed by a write process and multiple read processes. Next, the block storage manager manages one or more data structures storing mappings that include block identifiers (IDs) of blocks representing chunks of the shared memory, files in the blocks, and directories containing the files. The block storage manager then applies an update by the write process to a subset of the blocks by atomically replacing, in the one or more data structures, a first directory containing an old version of the subset of the blocks with a second directory containing a new version of the subset of the blocks.

### RELATED APPLICATION

The subject matter of this application is related to the subject matter in a co-pending non-provisional application entitled “Edge Store Designs for Graph Databases,” having Ser. No. 15/360,605 and filing date 23 Nov. 2016 (Attorney Docket No. LI-900847-US-NP).

### BACKGROUND

### Field

The disclosed embodiments relate to techniques for managing inter-process communication. More specifically, the disclosed embodiments relate to a memory abstraction for lock-free inter-process communication.

### Related Art

Data associated with applications is often organized and stored in databases. For example, in a relational database data is organized based on a relational model into one or more tables of rows and columns, in which the rows represent instances of types of data entities and the columns represent associated values. Information can be extracted from a relational database using queries expressed in a Structured Query Language (SQL).

In principle, by linking or associating the rows in different tables, complicated relationships can be represented in a relational database. In practice, extracting such complicated relationships usually entails performing a set of queries and then determining the intersection of the results or joining the results. In general, by leveraging knowledge of the underlying relational model, the set of queries can be identified and then performed in an optimal manner.

However, applications often do not know the relational model in a relational database. Instead, from an application perspective, data is usually viewed as a hierarchy of objects in memory with associated pointers. Consequently, many applications generate queries in a piecemeal manner, which can make it difficult to identify or perform a set of queries on a relational database in an optimal manner. This can degrade performance and the user experience when using applications.

Various approaches have been used in an attempt to address this problem, including using an object-relational mapper, so that an application effectively has an understanding or knowledge about the relational model in a relational database. However, it is often difficult to generate and to maintain the object-relational mapper, especially for large, real-time applications.

Alternatively, a key-value store (such as a NoSQL database) may be used instead of a relational database. A key-value store may include a collection of objects or records and associated fields with values of the records. Data in a key-value store may be stored or retrieved using a key that uniquely identifies a record. By avoiding the use of a predefined relational model, a key-value store may allow applications to access data as objects in memory with associated pointers (i.e., in a manner consistent with the application's perspective). However, the absence of a relational model means that it can be difficult to optimize a key-value store. Consequently, it can also be difficult to extract complicated relationships from a key-value store (e.g., it may require multiple queries), which can also degrade performance and the user experience when using applications.

### BRIEF DESCRIPTION OF THE FIGURES

FIG. 1 shows a schematic of a system in accordance with the disclosed embodiments.

FIG. 2 shows a graph in a graph database in accordance with the disclosed embodiments.

FIG. 3 shows a system for managing inter-process communication in accordance with the disclosed embodiments.

FIG. 4 shows a flowchart illustrating a process of managing inter-process communication in accordance with the disclosed embodiments.

FIG. 5 shows a flowchart illustrating a process of atomically replacing multiple blocks in shard memory in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for managing inter-process communication. In these embodiments, inter-process communication is conducted between a single write process and multiple read processes as the processes perform read, write, and/or other operations on data and/or data structures such as databases and/or indexes.

More specifically, the disclosed embodiments provide a method, apparatus, and system that implement a memory abstraction for lock-free inter-process communication. The memory abstraction includes blocks representing contiguous chunks of memory shared by the processes, as well as a block storage manager that manages the memory abstraction and performs operations that allow the processes to access and/or update the blocks. For example, the processes may interact with an application programming interface (API) with the block storage manager to create blocks representing files and directories, open the files and/or directories into the corresponding blocks, resize the blocks, and/or close the files and/or directories. To open a file for a process, the block storage manager maps the file to a block and maps the contents of the block into the virtual address space of the process. To close a file for the process, the block storage manager removes the block from the process's address space and decreasess the file's reference count within the underlying operating system kernel.

The processes additionally interact with the block storage manager to perform atomic updates of files and/or directories. For example, the write process periodically performs compaction of a database index stored in one or more blocks. To replace a given block with a newer, compacted version of the block, the write process creates a new block, write a compacted version of the block to the new block, and requests that the block storage manager replace the block with the new version. In turn, the block storage manager atomically replaces a reference to the old block with a reference to the new block in one or more data structures for managing the memory abstraction.

The write process also, or instead, atomically replaces multiple blocks with newer versions of the blocks by grouping the old blocks and new blocks under different directories and requesting that the block storage manager replace the directory containing the old blocks with the directory containing the new blocks. In turn, the block storage manager may atomically update an entry for the old directory in the data structure(s) with a new version and/or another indication that the old directory has been modified or replaced.

By providing a block-based abstraction over memory that is shared by a write process and multiple read processes, the disclosed embodiments maintain a consistent view of the shared memory by the read processes independently of writes to the shared memory by the write process. Operations supported by the disclosed embodiments are also carried out atomically, which allows the write and read processes to access and/or modify the shared memory without locks. The disclosed embodiments further retain older versions of blocks while the older versions are used by read processes, thereby decoupling reads performed by the read processes from writes performed by the write process.

In contrast, conventional techniques use locks to coordinate execution and/or communication among read and write processes. Such locking behavior can increase latency, memory usage, and/or processor execution required to implement the locks. Use of locks may additionally result in lock contention, instability, priority inversion, lock-based bugs, or deadlock. Conversely, the conventional techniques may omit locks among read and wrote processes, which can cause the processes to have inconsistent views of the data and generate different and/or erroneous results for the same queries. Consequently, the disclosed embodiments improve processing times, overhead, latency, consistency, communication, and/or validity of computer systems, applications, and/or technologies for processing queries of data stores and/or updating the data stores.

### Memory Abstraction for Lock-Free Inter-Process Communication

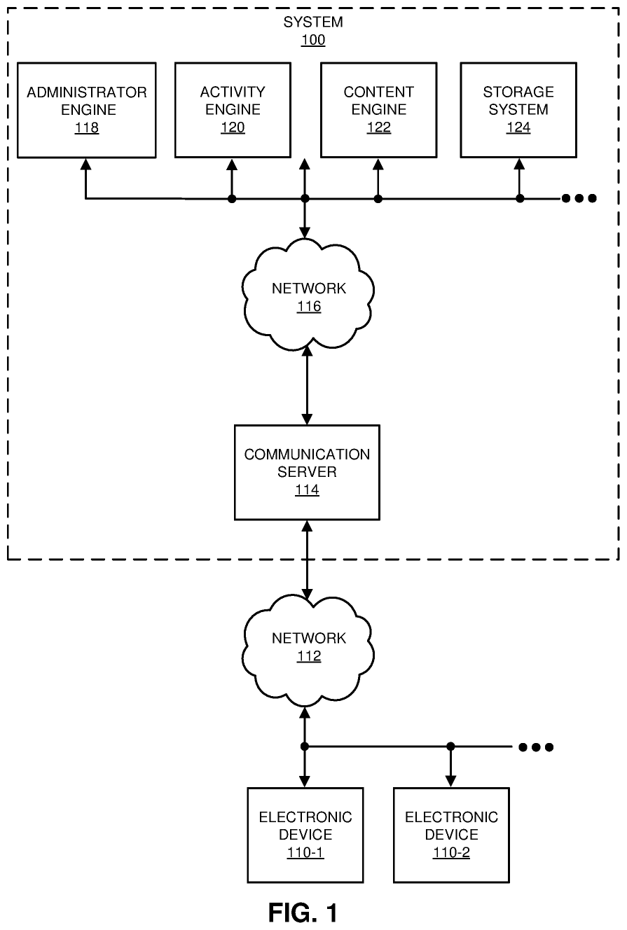

FIG. 1 shows a schematic of a system 100 in accordance with the disclosed embodiments. In this system, users of electronic devices 110 use a service that is provided, at least in part, using one or more software products or applications executing in system 100. As described further below, the applications are executed by engines in system 100.

Moreover, the service is provided, at least in part, using instances of a software application that is resident on and that executes on electronic devices 110. In some implementations, the users interact with a web page that is provided by communication server 114 via network 112, and which is rendered by web browsers on electronic devices 110. For example, at least a portion of the software application executing on electronic devices 110 includes an application tool that is embedded in the web page, and that executes in a virtual environment of the web browsers. Thus, the application tool is provided to the users via a client-server architecture.

The software application operated by the users includes a standalone application or a portion of another application that is resident on and that executes on electronic devices 110 (such as a software application that is provided by communication server 114 or that is installed on and that executes on electronic devices 110).

A wide variety of services can be provided using system 100. In the discussion that follows, a social network (and, more generally, a user community), such as an online professional network, which facilitates interactions among the users, is used as an illustrative example. Moreover, using one of electronic devices 110 (such as electronic device 110-1) as an illustrative example, a user of an electronic device uses the software application and one or more of the applications executed by engines in system 100 to interact with other users in the social network. For example, administrator engine 118 handles user accounts and user profiles, activity engine 120 tracks and aggregate user behaviors over time in the social network, content engine 122 receives user-provided content (audio, video, text, graphics, multimedia content, verbal, written, and/or recorded information) and provides documents (such as presentations, spreadsheets, word-processing documents, web pages, etc.) to users, and storage system 124 maintains data structures in a computer-readable memory that encompasses multiple devices, i.e., a large-scale storage system.

Note that each of the users of the social network have an associated user profile that includes personal and professional characteristics and experiences, which are sometimes collectively referred to as ‘attributes’ or ‘characteristics.’ For example, a user profile includes: demographic information (such as age and gender), geographic location, work industry for a current employer, an employment start date, an optional employment end date, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network.

Furthermore, the interactions among the users help define a social graph in which nodes correspond to the users and edges between the nodes correspond to the users' interactions, interrelationships, and/or connections. However, as described further below, the nodes in the graph stored in the graph database can correspond to additional or different information than the members of the social network (such as users, companies, etc.). For example, the nodes may correspond to attributes, properties or characteristics of the users.

It can be difficult for the applications to store and retrieve data in existing databases in storage system 124 because the applications may not have access to the relational model associated with a particular relational database (which is sometimes referred to as an ‘object-relational impedance mismatch’). Moreover, if the applications treat a relational database or key-value store as a hierarchy of objects in memory with associated pointers, queries executed against the existing databases may not be performed in an optimal manner.

For example, when an application requests data associated with a complicated relationship (which may involve two or more edges, and which is sometimes referred to as a ‘compound relationship’), a set of queries are performed and then the results may be linked or joined. To illustrate this problem, rendering a web page for a blog may involve a first query for the three-most-recent blog posts, a second query for any associated comments, and a third query for information regarding the authors of the comments. Because the set of queries may be suboptimal, obtaining the results can, therefore, be time-consuming. This degraded performance can degrade the user experience when using the applications and/or the social network.

In order to address these problems, storage system 124 includes a graph database that stores a graph (e.g., as part of an information-storage-and-retrieval system or engine). Note that the graph allows an arbitrarily accurate data model to be obtained for data that involves fast joining (such as for a complicated relationship with skew or large ‘fan-out’ in storage system 124), which approximates the speed of a pointer to a memory location (and thus may be well suited to the approach used by applications).

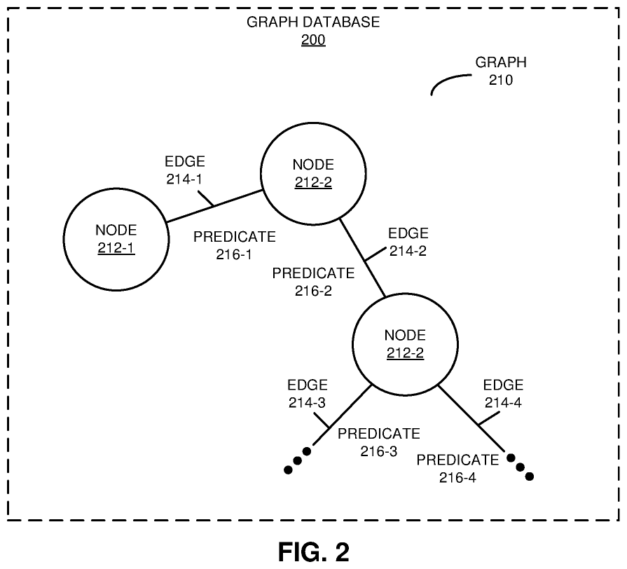

FIG. 2 presents a block diagram illustrating a graph 210 stored in a graph database 200 in system 100 (FIG. 1). Graph 210 includes nodes 212 and edges 214 between nodes 212 to represent and store the data with index-free adjacency, i.e., so that each node 212 in graph 210 includes a direct edge to its adjacent nodes without using an index lookup.

In one or more embodiments, graph database 200 includes an implementation of a relational model with constant-time navigation, i.e., independent of the size N, as opposed to varying as log(N). Moreover, all the relationships in graph database 200 are first class (i.e., equal). In contrast, in a relational database, rows in a table may be first class, but a relationship that involves joining tables may be second class. Furthermore, a schema change in graph database 200 (such as the equivalent to adding or deleting a column in a relational database) is performed with constant time (in a relational database, changing the schema can be problematic because it is often embedded in associated applications). Additionally, for graph database 200, the result of a query includes a subset of graph 210 that preserves the structure (i.e., nodes, edges) of the subset of graph 210.

The graph-storage technique includes embodiments of methods that allow the data associated with the applications and/or the social network to be efficiently stored and retrieved from graph database 200. Such methods are described in U.S. Pat. No. 9,535,963 (issued 3 Jan. 2017), entitled “Graph-Based Queries,” which is incorporated herein by reference.

Referring back to FIG. 1, the graph-storage techniques described herein allow system 100 to efficiently and quickly (e.g., optimally) store and retrieve data associated with the applications and the social network without requiring the applications to have knowledge of a relational model implemented in graph database 200. Consequently, the graph-storage techniques improve the availability and the performance or functioning of the applications, the social network and system 100, which reduce user frustration and improve the user experience. Therefore, the graph-storage techniques further increase engagement with or use of the social network and, in turn, the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

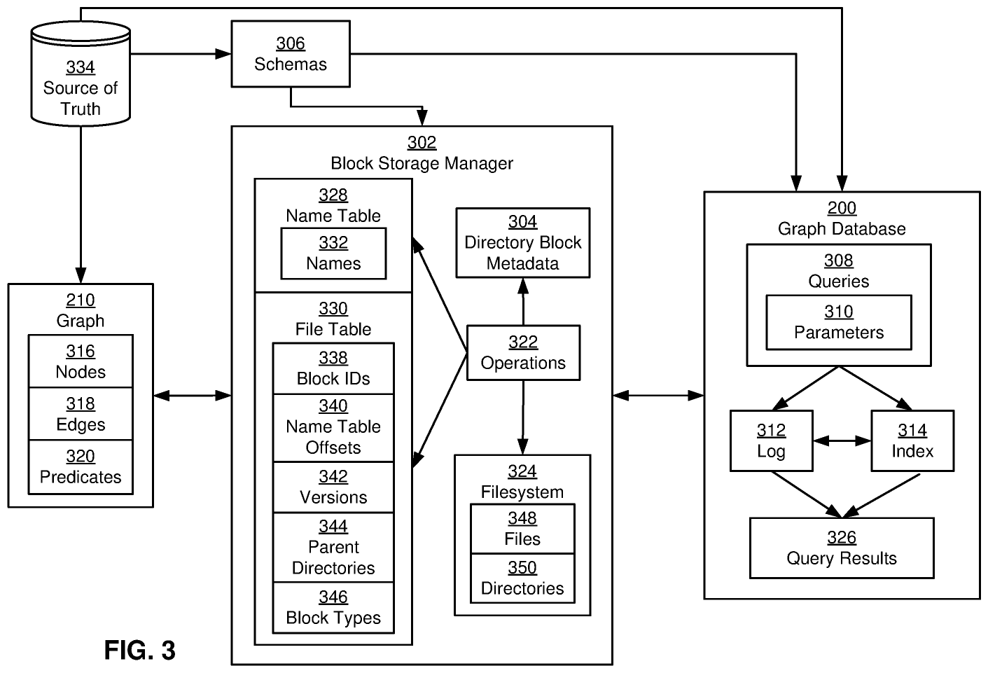

In one or more embodiments, graph database 200 includes functionality to perform lock-free execution and communication between multiple processes for accessing graph database 200. As shown in FIG. 3, graph 210 and one or more schemas 306 associated with graph 210 are obtained from a source of truth 334 for graph database 200. For example, graph 210 and schemas 306 may be retrieved from a relational database, distributed filesystem, and/or other storage mechanism providing the source of truth.

As mentioned above, graph 210 includes a set of nodes 316, a set of edges 318 between pairs of nodes, and a set of predicates 320 describing the nodes and/or edges. Each edge in graph 210 may be specified in a (subject, predicate, object) triple. For example, an edge denoting a connection between two members named “Alice” and “Bob” may be specified using the following statement:
Edge(“Alice”, “ConnectedTo”, “Bob”).
   In the above statement, “Alice” is the subject, “Bob” is the object, and “ConnectedTo” is the predicate. A period following the “Edge” statement may denote an assertion that is used to write the edge to graph database 200. Conversely, the period may be replaced with a question mark to read any edges that match the subject, predicate, and object from the graph database:
Edge(“Alice”, “ConnectedTo”, “Bob”)?
   Moreover, a subsequent statement may modify the initial statement with a tilde to indicate deletion of the edge from graph database 200:
Edge˜(“Alice”, “ConnectedTo”, “Bob”).

In addition, specific types of edges and/or complex relationships in graph 210 are defined using schemas 306. Continuing with the previous example, a schema for employment of a member at a position within a company may be defined using the following:

DefPred(“employ/company”, “1”, “node”, “0”, “node”).
DefPred(“employ/member”, “1”, “ node”, “0”, “node”).
DefPred(“employ/start”, “1”, “node”, “0”, “date”).
DefPred(“employ/end_date”, “1”, “node”, “0”,

“date”).

M2C@(e, memberId, companyId, start, end) :-

Edge(e, “employ/member”, memberId),
Edge(e, “employ/company”, companyId),
Edge(e, “employ/start”, start),
Edge(e, “employ/end_date”, end)

In the above schema, a compound structure for the employment is denoted by the “@” symbol and has a compound type of “M2C.” The compound is represented by four predicates and followed by a rule with four edges that use the predicates. The predicates include a first predicate representing the employment at the company (e.g., “employ/company”), a second predicate representing employment of the member (e.g., “employ/member”), a third predicate representing a start date of the employment (e.g., “employ/start”), and a fourth predicate representing an end date of the employment (e.g., “employ/end_date”). Each predicate is defined using a corresponding “DefPred” call; the first argument to the call represents the name of the predicate, the second argument of the call represents the cardinality of the subject associated with the edge, the third argument of the call represents the type of subject associated with the edge, the fourth argument represents the cardinality of the object associated with the edge, and the fifth argument represents the type of object associated with the edge.

In the rule, the first edge uses the second predicate to specify employment of a member represented by “memberId,” and the second edge uses the first predicate to specify employment at a company represented by “companyId.” The third edge of the rule uses the third predicate to specify a “start” date of the employment, and the fourth edge of the rule uses the fourth predicate to specify an “end” date of the employment. All four edges share a common subject denoted by “e,” which functions as a hub node that links the edges to form the compound relationship.

In another example, a compound relationship representing endorsement of a skill in an online professional network includes the following schema:

DefPred(“endorser”, “1”, “node”, “0”, “node”)
DefPred(“endorsee”, “1”, “node”, “0”, “node”)
DefPred(“skill”, “1”, “node”, “0”, “node”).
Endorsement@(h, Endorser, Endorsee, Skill) :-

Edge(h, “endorser”, Endorser),
Edge(h, “endorsee”, Endorsee),
Edge(h, “skill”, Skill).

In the above schema, the compound relationship is declared using the “@” symbol and specifies “Endorsement” as a compound type (i.e., data type) for the compound relationship. The compound relationship is represented by three predicates defined as “endorser,” “endorsee,” and “skill.” The “endorser” predicate may represent a member making the endorsement, the “endorsee” predicate may represent a member receiving the endorsement, and the “skill” predicate may represent the skill for which the endorsement is given. The declaration is followed by a rule that maps the three predicates to three edges. The first edge uses the first predicate to identify the endorser as the value specified in an “Endorser” parameter, the second edge uses the second predicate to identify the endorsee as the value specified in an “Endorsee” parameter, and the third edge uses the third predicate to specify the skill as the value specified in a “Skill” parameter. All three edges share a common subject denoted by “h,” which functions as a hub node that links the edges to form the compound relationship. Consequently, the schema may declare a ternary relationship for an “Endorsement” compound type, with the relationship defined by identity-giving attributes with types of “endorser,” “endorsee,” and “skill” and values attached to the corresponding predicates.

In one or more embodiments, compounds stored in graph database 200 model complex relationships (e.g., employment of a member at a position within a company) using a set of basic types (i.e., binary edges 318) in graph database 200. Each compound represents an n-ary relationship in graph 210, with each “component” of the relationship identified using the predicate and object (or subject) of an edge. A set of “n” edges that model the relationship are then linked to the compound using a common subject (or object) that is set to a hub node representing the compound. In turn, new compounds are subsequently dynamically added to graph database 200 without changing the basic types used in graph database 200, by specifying relationships that relate the compound structures to the basic types in schemas 306.

Graph 210 and schemas 306 are used to populate graph database 200 for processing queries 308 against the graph. In some embodiments, a representation of nodes 316, edges 318, and predicates 320 is obtained from source of truth 334 and stored in a log 312 in the graph database. Lock-free access to graph database 200 is implemented by appending changes to graph 210 to the end of the log instead of requiring modification of existing records in source of truth 334. In turn, graph database 200 provides an in-memory cache of log 312 and an index 314 for efficient and/or flexible querying of the graph.

In some embodiments, nodes 316, edges 318, and predicates 320 are stored as offsets in log 312. For example, the exemplary edge statement for creating a connection between two members named “Alice” and “Bob” may be stored in a binary log 312 using the following format:

| | |
|---|---|
| 256 | Alice |
| 261 | Bob |
| 264 | ConnectedTo |
| 275 | (256, 264, 261) |

In the above format, each entry in the log is prefaced by a numeric (e.g., integer) offset representing the number of bytes separating the entry from the beginning of the log. The first entry of “Alice” has an offset of 256, the second entry of “Bob” has an offset of 261, and the third entry of “ConnectedTo” has an offset of 264. The fourth entry has an offset of 275 and stores the connection between “Alice” and “Bob” as the offsets of the previous three entries in the order in which the corresponding fields are specified in the statement used to create the connection (i.e., Edge(“Alice”, “ConnectedTo”, “Bob”)).

Because the ordering of changes to graph 210 is preserved in log 312, offsets in log 312 can be used as representations of virtual time in graph 210. More specifically, each offset represents a different virtual time in graph 210, and changes in the log up to the offset are used to establish a state of graph 210 at the virtual time. For example, the sequence of changes from the beginning of log 312 up to a given offset that is greater than 0 are applied, in the order in which the changes were written, to construct a representation of graph 210 at the virtual time represented by the offset.

Graph database 200 further omits duplication of nodes 316, edges 318, and predicates 320 of graph 210 in log 312. Thus, a node, edge, predicate, and/or other element of graph 210 that has already been added to log 312 will not be rewritten at a subsequent point in log 312.

Graph database 200 also includes an in-memory index 314 that enables efficient lookup of edges 318 by subject, predicate, object, and/or other keys or parameters 310. In some embodiments, the index structure includes a hash map and an edge store. The hash map and edge store are accessed simultaneously by a number of processes, including a single write process and multiple read processes. Entries in the hash map are accessed using keys or parameters 310 such as subjects, predicates, and/or objects that partially define edges in the graph. In turn, the entries include offsets into the edge store that are used to resolve and/or retrieve the corresponding edges. Edge store designs for graph database indexes are described in a co-pending non-provisional application entitled “Edge Store Designs for Graph Databases,” having Ser. No. 15/360,605, and filing date 23 Nov. 2016 (Attorney Docket No. LI-900847-US-NP), which is incorporated herein by reference.

In one or more embodiments, a block storage manager 302 manages lock-free inter-process communication and/or access to log 312, index 314, and/or other data in graph database 200 by the write process and multiple read processes. In these embodiments, block storage manager 302 provides a memory abstraction that represents files 348 and directories 350 in an underlying filesystem 324 as blocks that occupy segments or chunks of shared memory. The read and write processes interact with block storage manager 302 to access and/or update files 348 and directories 350 in a lock-free manner. For example, the read and write processes may call an application programming interface (API) with block storage manager 302 to open, access, and/or close log 312 and hash maps and edge stores in index 314 as files under blocks representing the corresponding files 348 and directories 350.

More specifically, block storage manager 302 stores metadata for creating, managing, and/or updating blocks representing files 348 and directories 350 in a name table 328, a file table 330, and/or directory block metadata 338. Name table 328 stores names 332 of files 348 and directories 350 managed by block storage manager 302, and file table 330 stores metadata for blocks representing files 348 and directories 350.

As shown in FIG. 3, name table 328 includes names 332 of files 348 and/or directories 350, and file table 330 includes name table offsets 340 that reference names 332 in name table 328. For example, name table 328 may include a log or list of names 332 of files 348 and directories 350 managed by block storage manager 302, with each name identified by a numeric offset into name table 328. Each entry in file table 330 may represent a different file or directory, with the name table offset stored in the entry used to retrieve the name of the corresponding file or directory.

Entries in file table 330 additionally specify block identifiers (IDs) 338, versions 342, parent directories 344, and/or block types 346 of the corresponding files 348 and/or directories 350. In some embodiments, block IDs 338 include numeric and/or other IDs that uniquely identify the corresponding blocks. For example, each entry in file table 330 represents or defines a different block created and/or managed by block storage manager 302, with the block ID of the block represented by a corresponding row number, offset, key, and/or other numeric value related to the entry in file table 330.

In some embodiments, versions 342 track changes to the corresponding files 348 and directories 350. For example, block storage manager 302 initially assigns a version number of 0 to a given file or directory after creating or opening the file or directory within a corresponding block. When the file or directory is updated and/or replaced with a newer version (e.g., by the write process), block storage manager 302 increments the version number to indicate a change to the file or directory.

In some embodiments, parent directories 344 include block IDs 338 of directories 350 in which the corresponding blocks are located, and block types 346 include Boolean and/or other values indicating whether or not the corresponding blocks represent directories 350 (i.e., a block type of 1 indicates that the corresponding block represents a directory, and a block type of 0 indicates that the corresponding block represents a file). For example, block storage manager 302 initializes file table 330, name table 328, and a root directory in filesystem 324 by writing the following entries to file table 330:

| Block | Name Table | | Parent | Block |
|---|---|---|---|---|
| ID | Offset | Version | Directory | Type |
| 0 | 0 | 0 | −2 | 1 |
| 1 | 15 | 0 | −2 | 1 |
| 2 | 30 | 0 | −1 | 1 |

Continuing with the above example, block storage manager 302 also stores the following names 332 in name table 328:

| | | | | | | | | | | | | | | | | | | | |
|---|---|---|---|---|---|---|---|---|---|---|---|---|---|---|---|---|---|---|---|
| 0 | 0 | 1 | 1 | f | i | l | e | _{—} | t | a | b | l | e | \0 | 0 | 0 | 1 | 1 | n |
| a | m | e | _{—} | t | a | b | l | e | \0 | 0 | 0 | 0 | 5 | r | o | o | t | \0 | |

The example name table 328 above includes a list of names 332. Each entry in name table 328 is identified by a sequence of special characters (i.e., “00”), which is followed by the length of the corresponding name and the actual name. The first entry indicates a length of 11 characters and a name of “file table,” the second entry indicates a length of 11 characters and a name of “name table,” and the third entry indicates a length of five characters and a name of “root.” A null character (i.e., “\0”) is appended to each name to represent the end of the corresponding name table 328 entry.

All three entries in the example file table 330 have versions 342 of 0 and block types 346 of 1, indicating that the corresponding blocks represent original versions of directories 350 in filesystem 324. The first entry has a block ID of 0, an offset of 0 into name table 328, and a parent directory block ID of −2, and the second entry has a block ID of 1, an offset of 15 into name table 328, and a parent directory block ID of −2. The first entry thus defines a block representing file table 330, and the second entry defines a block representing name table 328. The third entry in the example file table 330 has a block ID of 2, an offset of 30 into name table 328, and a parent directory block ID of −1. As a result, the third entry defines a root directory in filesystem 324, under which all other files 348 and directories 350 managed by block storage manager 302 reside. A special value of −2 may be stored under parent directories 344 of the entries for file table 330 and name table 328 to indicate that the corresponding blocks store top-level metadata for all other blocks managed by block storage manager 202. Similarly, a special value of −1 may be stored under the parent directory of the entry for the root directory to indicate that the corresponding block represents the highest level directory in filesystem 324.

Block storage manager 302 additionally maintains directory block metadata 304 for name table 328, file table 330, the root directory, and/or other directories 350 in filesystem 324. For example, block storage manager 302 creates a separate file in filesystem 324 to store directory block metadata 304 for each block representing a directory in file table 330. The name of the file includes the block ID of the corresponding block, followed by the version of the corresponding block. Thus, directory block metadata 304 for the first three entries in the example file table 330 above may be stored in three files; the first file includes a filename of “0-0” for the block representing file table 330, the second file includes a filename of “1-0” for the block representing name table 328, and the third file includes a filename of “2-0” for the block representing the root directory. In turn, each file contains directory block metadata 304 such as, but not limited to, the block ID of the corresponding directory and/or block IDs 338 of files 348 and/or directories 350 that reside within the directory.

In one or more embodiments, block storage manager 302 performs operations 322 that update name table 328, file table 330, directory block metadata 304, and/or filesystem 324 to allow access to the corresponding files 348 and directories 350 by read and write processes that process queries 308 of graph database 200. As mentioned above, the processes are able to request operations 322 by interacting with an API with block storage manager 302.

In one or more embodiments, operations 322 include an operation for initializing block storage manager 302. For example, a write or read process invokes an “Initialize” operation to bootstrap a new instance of block storage manager 302. In turn, the instance creates and/or opens blocks representing name table 328, file table 330, and the root directory; updates name table 328, file table 330, and directory block metadata 304 with entries for the blocks (e.g., the example entries shown above); and maps the blocks into the caller's virtual address space. Subsequent invocations of the “initialize” operation by other processes map the blocks into the processes' virtual address spaces and allow the processes to access name table 328, file table 330, directory block metadata 304, and/or other metadata representing blocks managed by block storage manager 302.

Operations 322 also, or instead, include one or more operations 322 for creating, opening, and/or accessing blocks representing files 348. For example, a write process invokes a “CreateBlock” operation to create a block representing a file. Arguments to the operation include, but are not limited to, the name of the file and/or the block ID of a parent directory for the file. Alternatively, the write process omits arguments to the operation to create the block as an “anonymous” unnamed temporary block to which the write process can write before the temporary block is swapped in as a replacement for an older version of the block. In response to the invocation, block storage manager 302 creates the file within the specified parent directory (or the root directory, if no parent directory is specified) in filesystem 324, adds entries representing the file in file table 330 and name table 328, and returns with the block ID of the newly created block.

In another example, a write and/or read process invokes an “Open” operation to open the file backing a previously created block. In response to the invocation, block storage manager 302 opens the file, caches the file descriptor, and maps the block's contents into the calling process's virtual address space (e.g., by providing the calling process a usable pointer to the base of the block). The mapping can be read-only for read processes and read-write for the write process. After “Open” is called by multiple processes, the same portion of physical space is mapped to the virtual address spaces of the processes. As a result, writes by the write process are seen immediately by the read processes and asynchronously propagated back to the underlying file by the operating system kernel on the same computer system. Moreover, each process maintains an in-memory data structure that parallels file table 330 and tracks block IDs 338, name table offsets 340, versions 342, parent directories 344, and/or block types 346 of opened blocks. The in-memory data structure additionally stores, for each opened block, a corresponding base pointer, file descriptor, mapped size, and/or other attributes that allow the process to read and/or write to the block's contents.

Similarly, block storage manager 302 supports operations 322 for creating, opening, and/or accessing blocks representing directories 350. For example, the write process invokes a “CreateDirBlock” operation to create a block representing a directory. Arguments to the operation include, but are not limited to, the name of the directory and/or the block ID of the parent directory under which the directory is to be created. The arguments can be omitted to create the block as an “anonymous” unnamed temporary block. In response to the invocation, block storage manager 302 creates the directory within the specified parent directory (or the root directory, if no parent directory is specified) in filesystem 324, adds entries representing the directory in file table 330 and name table 328, and returns with the block ID of the newly created block.

In another example, a write and/or read process invokes a “DirOpen” operation to open the directory represented by a block. In response to the invocation, block storage manager 302 opens and/or re-opens the directory for the calling process, along with blocks representing files and/or directories found under the directory.

Block storage manager 302 additionally supports operations 322 for resizing blocks. For example, the write process invokes a “GrowBy” operation with block storage manager 302 to increase the size of a block in memory. Arguments to the operation include, but are not limited to, the block ID of the block and/or the new size of the block (e.g., in number of bytes). Block storage manager 302 carries out the operation by invoking a corresponding “ftruncate” or “truncate” system call. After the block is resized, remaining processes (e.g., read processes) can call a “Remap” function to remap the block to the processes' virtual address spaces.

In one or more embodiments, block storage manager 302 includes functionality to atomically replace blocks representing files 348 and/or directories 350 with newer versions of the blocks. In turn, block storage manager 302 provides a consistent view of files 348 and directories 350 to the processes, thereby allowing the processes to execute and/or communicate without locks.

For example, the write process replace sa block containing log 312 with a newer version of log 312 (e.g., from source of truth 334 and/or another source of graph data). To do so, the write process creates a new block, opens the newer version of log 312 into the new block, and invokes a “Become” operation with block storage manager 302 with block IDs of the existing and new versions of log 312 as arguments of the operation. Block storage manager 302 carries out the operation as a word-aligned, 64-bit write that modifies the row representing the old version of log 312 in file table 330 to point to the new block. Because such writes are guaranteed to be atomic on x86-64 architectures, no lock is required.

After the operation is carried out, each read process continues to access the old block until the process explicitly calls a “Reopen” operation that reopens the new version of the block into the process's virtual address space. Thus, the read process is able to complete existing read queries 308 with the old block and/or retain access to the old block independently of the write process's replacement of the old block with the new block. After all processes have opened the new version of the block and/or closed the old version of the block, the old version of the block is deleted from filesystem 324.

In another example, the write process atomically replaces multiple blocks containing hash maps, edge stores, and/or other portions of index 314 with newer and/or compacted versions of the portions. To do so, the write process groups blocks containing the hash maps, edge stores, and/or other portions of a certain version of index 314 under a single directory. The write process also creates new versions of the blocks under a new version of the directory and writes new and/or compacted data for the corresponding portions of index 314 to the new blocks. After writing to the new blocks is complete, the write process invokes a “Become” operation with block storage manager 302 and passes block IDs of the old and new directories as arguments of the operation.

Block storage manager 302 then carries out the operation using a series of atomic steps. First, block storage manager 302 renames directory block metadata 304 for the new block to the name of the old directory followed by an incremented version for the old directory. Next, block storage manager 302 renames the new directory to the name of the old directory followed by the incremented version of the old directory and stores the new directory under the parent directory of the old directory. Block storage manager 302 then updates file table 330 so that entries for files 348 and/or directories 350 found under the new directory reflect the new directory name and/or path. Finally, block storage manager 302 performs a word-aligned atomic write that updates an entry for the old directory in file table 330 to increment the version of the directory, thereby indicating to other (e.g., read) processes that a newer version of the directory (and any changes to underlying files and/or directories) is available.

After the operation is complete, read processes can invoke a “DirOpen” operation to reopen the directory. In turn, block storage manager 302 opens the directory and opens sub-blocks of the directory when the directory's version in file table 330 has changed. Consequently, the final step of the “Become” operation atomically increments the version number of the directory in file table 330 so that the read processes have a consistent view of the directory and any files 348 and/or directories 350 within the directory.

The use of block storage manager 302 with graph database 200 is illustrated using the following example sequence of operations 322 and the previous example file table 330 and name table 328 entries for file table 330, name table 328, and the root directory of filesystem 324:
bsm.CreateBlock(“graph.limg”, 2)
bsm.CreateDirBlock(“op”, 2)
bsm.CreateBlock(“edge_store_l1.index”, 4)
bsm.CreateBlock(“edge_store_l2.index”, 4)
   In the above sequence, the first operation creates a block representing a file named “graph.limg” under a parent directory with a block ID of 2, and the second operation creates a block representing a directory named “op” under the same parent directory. After the first two operations are carried out, file table 330 includes two new entries after the first three entries for file table 330, name table 328, and the root directory:

| Block | Name Table | | Parent | Block |
|---|---|---|---|---|
| ID | Offset | Version | Directory | Type |
| 0 | 0 | 0 | −2 | 1 |
| 1 | 15 | 0 | −2 | 1 |
| 2 | 30 | 0 | −1 | 1 |
| 3 | 39 | 0 | 2 | 0 |
| 4 | 54 | 0 | 2 | 1 |

The first new entry (i.e., the fourth entry in file table 330) includes a block ID of 3, a name table offset of 39 (e.g., representing a name of “graph.limg” stored in name table 328), a version of 0, a parent directory with a block ID of 2 (i.e., the root directory), and a block type of 0. The second new entry (i.e., the fifth entry in file table 330) includes a block ID of 4, a name table offset of 54 (e.g., representing a name of “op” stored in name table 328), a version of 0, the same parent directory with a block ID of 2, and a block type of 1. The fifth entry is accompanied by the creation of a file named “4-0” that stores directory block metadata 304 for the “op” directory.

The third and fourth operations create files named “edge_store_l1.index” and “edge_store_l2.index” under the “op” directory represented by the block ID of 4. For example, a write process uses the third and fourth operations to create multiple blocks storing different portions of index 314 under the “op” directory. After the third and fourth operations are complete, file table 330 includes a sixth and seventh entry for the two newly created files:

| Block | Name Table | | Parent | Block |
|---|---|---|---|---|
| ID | Offset | Version | Directory | Type |
| 0 | 0 | 0 | −2 | 1 |
| 1 | 15 | 0 | −2 | 1 |
| 2 | 30 | 0 | −1 | 1 |
| 3 | 39 | 0 | 2 | 0 |
| 4 | 54 | 0 | 2 | 1 |
| 5 | 61 | 0 | 4 | 0 |
| 6 | 79 | 0 | 4 | 0 |

Similarly, filesystem 324 includes a file named “graph-0.limg” and a directory named “op-0” under a “root-0” directory, and two files named “edge_store_l1-0.index” and “edge_store_l2-0.index” under the “op-0” directory. Thus, block storage manager 302 appends versions 342 in file table 330 to the names of the corresponding files 348 and directories 350 in filesystem 324.

An additional sequence of operations 322 can be used to replace the two files created under the “op-0” directory with new versions of the files and directory:
bsm.CreateDirBlock( )
bsm.CreateBlock(“edge_store_l1.index”, 7)
bsm.CreateBlock(“edge_store_l2.index”, 7)
bsm.Become(4, 7)
   The first operation in the above sequence creates a block representing an anonymous directory. After the first operation is performed, file table 330 includes an eighth entry for the anonymous directory:

| Block | Name Table | | Parent | Block |
|---|---|---|---|---|
| ID | Offset | Version | Directory | Type |
| 0 | 0 | 0 | −2 | 1 |
| 1 | 15 | 0 | −2 | 1 |
| 2 | 30 | 0 | −1 | 1 |
| 3 | 39 | 0 | 2 | 0 |
| 4 | 54 | 0 | 2 | 1 |
| 5 | 61 | 0 | 4 | 0 |
| 6 | 79 | 0 | 4 | 0 |
| 7 | 97 | 0 | −3 | 1 |

The eighth entry includes a block ID of 7, a name table offset of 97, a version of 0, a parent directory block ID of −3 (which indicates an anonymous directory), and a block type of 1.

In turn, the block ID of 7 for the newly created anonymous directory is included as an argument to the next two operations, which create files with names that are identical to those of the files associated with block IDs of 5 and 6 under the anonymous directory. After the two operations are performed, file table 330 is updated with a ninth and tenth entry representing the two newly created files:

| Block | Name Table | | Parent | Block |
|---|---|---|---|---|
| ID | Offset | Version | Directory | Type |
| 0 | 0 | 0 | −2 | 1 |
| 1 | 15 | 0 | −2 | 1 |
| 2 | 30 | 0 | −1 | 1 |
| 3 | 39 | 0 | 2 | 0 |
| 4 | 54 | 0 | 2 | 1 |
| 5 | 61 | 0 | 4 | 0 |
| 6 | 79 | 0 | 4 | 0 |
| 7 | 97 | 0 | −3 | 1 |
| 8 | 61 | 0 | 7 | 0 |
| 9 | 79 | 0 | 7 | 0 |

The ninth and tenth entries have block IDs of 8 and 9, respectively; name table offsets 340 that are the same as those of the files represented by block IDs of 5 and 6; the same version of 0; the same parent directory block ID of 7; and the same block type of 0. Moreover, filesystem 324 is updated to include a directory named “anonymous-0” under the “root-0” directory with two files named “edge_store_l1-0.index” and “edge_store_l2-0.index.”

Finally, the “Become” operation replaces the directory with the block ID of 4 with the newer directory with the block ID of 7. After the “Become” operation is carried out, file table 330 is updated to include the following:

| Block | Name Table | | Parent | Block |
|---|---|---|---|---|
| ID | Offset | Version | Directory | Type |
| 0 | 0 | 0 | −2 | 1 |
| 1 | 15 | 0 | −2 | 1 |
| 2 | 30 | 0 | −1 | 1 |
| 3 | 39 | 0 | 2 | 0 |
| 4 | 54 | 1 | 2 | 1 |
| 5 | 61 | −2 | 4 | 0 |
| 6 | 79 | −2 | 4 | 0 |
| 7 | 97 | −2 | −3 | 1 |
| 8 | 61 | 0 | 4 | 0 |
| 9 | 79 | 0 | 4 | 0 |

More specifically, the entry with block ID of 4 has an incremented version of 1, indicating that the corresponding directory has been updated and/or replaced. Entries with block IDs of 5, 6, and 7 have the same version of −2, indicating that the corresponding files and directories have been replaced or are no longer a part of the latest version of the filesystem. Entries with block IDs of 8 and 9 have a new parent directory block ID of 4, indicating that the corresponding files have been moved from the directory represented by block ID 7 to the directory represented by block ID 4.

Similarly, filesystem 324 includes a directory named “op-1” under the “root-0” directory instead of an older directory named “op-0.” The directory includes two files named “edge_store_l1-0.index” and “edge_store_l2-0.index,” which were previously under the “anonymous-0” directory. Moreover, the “4-0” file containing directory block metadata 304 for the old “op-0” directory is replaced with a “4-1” file containing directory block metadata 304 for the new “op-1” directory. Because other processes are notified of the new directory only after the directory's version is incremented in file table 330, updates applied by block storage manager 302 to file table 330 entries and/or filesystem 324 are not detected by the other processes until all updates are complete.

By providing a block-based abstraction over memory that is shared by a write process and multiple read processes, the system of FIG. 3 maintains a consistent view of the shared memory by the read processes independently of writes to the shared memory by the write process. Operations 322 supported by the system are also carried out atomically, which allows the write and read processes to access and/or modify the shared memory without locks. The system further retains older versions of blocks while the older versions are used by read processes, thereby decoupling reads performed by the read processes from writes performed by the write process.

In contrast, conventional techniques use locks to coordinate execution and/or communication among read and write processes. Such locking behavior can increase latency, memory usage, and/or processor overhead required to implement the locks. Use of locks may additionally result in lock contention, instability, priority inversion, lock-based bugs, or deadlock. Conversely, the conventional techniques may omit locks among read and wrote processes, which can cause the processes to have inconsistent views of the data and generate different and/or erroneous results for the same queries. Consequently, the disclosed embodiments improve processing times, overhead, latency, consistency, communication, and/or validity of computer systems, applications, and/or technologies for processing queries of data stores and/or updating the data stores.

Those skilled in the art will appreciate that the system of FIG. 3 may be implemented in a variety of ways. First, block storage manager 302, graph database 200, and/or source of truth 334 may be provided by a single physical machine, multiple computer systems, one or more virtual machines, a grid, one or more databases, one or more filesystems, and/or a cloud computing system. Block storage manager 302, graph database 200, and/or source of truth 334 may additionally be implemented together and/or separately by one or more hardware and/or software components and/or layers. For example, block storage manager 302 may be implemented as a utility that operates within and/or with graph database 200 and/or one or more APIs for accessing graph database 200.

Second, the functionality of the system may be used with other types of databases and/or data. For example, block storage manager 302 may support operations 322 on relational databases, streaming data, flat files, distributed filesystems, images, audio, video, and/or other types of data by a single write process and multiple read processes.

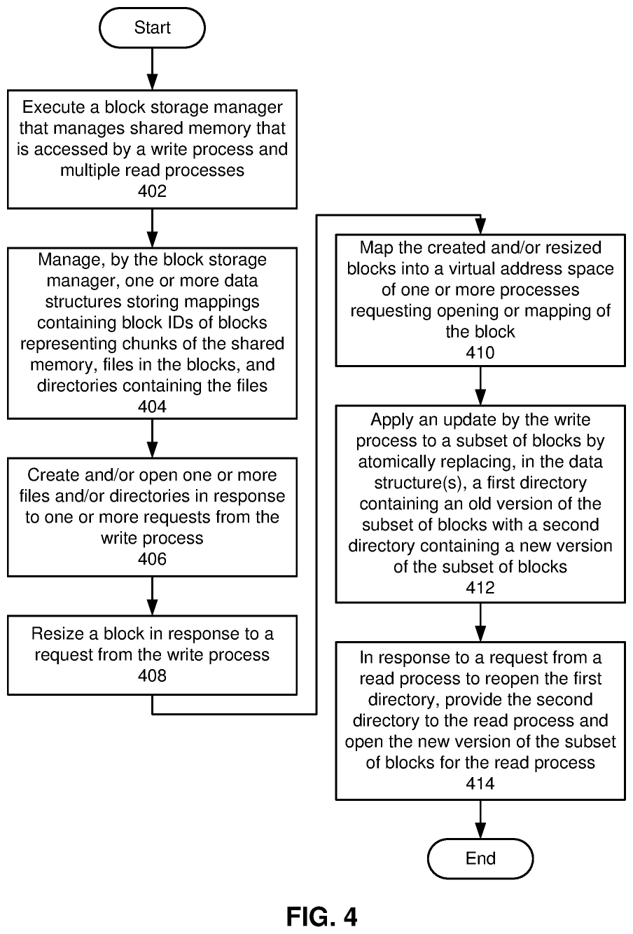

FIG. 4 shows a flowchart illustrating a process of managing inter-process communication in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a block storage manager that manages shared memory that is accessed by a write process and multiple read processes is executed (operation 402). For example, the block storage manager may be initialized by the write process and/or one of the read processes in a graph database.

Next, the block storage manager manages one or more data structures storing mappings containing block IDs of blocks representing chunks of the shared memory, files in the blocks, and directories containing the files (operation 404). For example, the block storage manager may maintain a name table that stores a list of file and/or directory names, as well as a file table that stores block IDs of the blocks, versions of the blocks, offsets into the name table, parent directories of the blocks, and/or block types of the blocks.

The block storage manager then carries out a number of operations for managing access to the shared memory by the write process and read processes. The operations include creating and/or opening one or more files and/or directories in response to one or more requests from the write process (operation 406). For example, an operation for creating a directory may be carried out by creating a directory block representing the directory in the file table, adding the directory's name to the name table, creating a file storing directory block metadata for the directory, and/or creating the directory within a filesystem on the computer system. In another example, an operation for creating a file may be carried out by updating the file table with an entry that includes a unique block ID for a block representing the file and/or adding the file's name to the name table. The file may optionally be created under a given parent directory by setting storing the parent directory's block ID under a corresponding “parent directory” field in the file table.

The operations also include resizing a block in response to a request from the write process (operation 408). For example, the resizing operation may be carried out by calling a “truncate” or “ftruncate” system call with the operating system on which the block storage manager resides and passing the block's new size as an argument to the system call.

After blocks are created and/or resized, the block storage manager maps the created and/or resized blocks into a virtual address space of one or more processes requesting opening or mapping of the block (operation 410). For example, the block storage manager may map a file represented by a block into a process's virtual address space after the process invokes an “Open” operation on the block. The block storage manager may subsequently remap the file into the process's virtual address space after the block is resized and the process invokes a “Reopen” operation on the block.

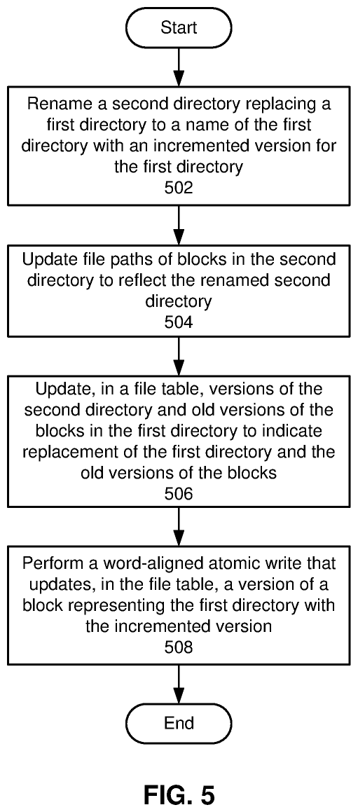

The operations further include applying an update by the write process to a subset of blocks by atomically replacing, in the data structure(s), a first directory containing an old version of the subset of blocks with a second directory containing a new version of the subset of blocks (operation 412). Atomically replacing multiple blocks in shared memory is described in further detail below with respect to FIG. 5.

In response to a request from a read process to reopen the first directory, the block storage manager provides the second directory to the read process and opens the new version of the subset of blocks for the read process (operation 414). For example, the read process can maintain access to the first directory and old version of the subset of blocks while the read process processes queries received before the first directory was replaced with the second directory. After the read process is done processing the queries, the read process may detect a new version of the first directory in the file table and invoke a “DirOpen” operation that reopens the first directory and maps the new version of the subset of blocks in the read process's virtual address space. The read process may then use the reopened directory and new block versions to process subsequent read queries.

FIG. 5 shows a flowchart illustrating a process of atomically replacing multiple blocks in shared memory in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a second directory replacing a first directory is renamed to the name of the first directory with an incremented version for the first directory (operation 502). For example, the first and second directories may include names of “A” and “B,” respectively, and the same version of 0. As a result, the name of the second directory and a corresponding file storing directory block metadata for the second directory may be changed from “B-0” to “A-1.” The path of the renamed directory may also be updated to include the parent directory of the first directory.

Next, file paths of blocks in the second directory are updated to reflect the renamed second directory (operation 504). For example, parent directories of the blocks may be updated to the block ID of the first directory.

Versions of the second directory and old versions of the blocks in the first directory are also updated in a file table to indicate replacement of the first directory and the old versions of the blocks (operation 506). For example, versions of the second directory and old versions of the blocks may be set to negative values in corresponding entries of the file table to indicate that the corresponding blocks have been deprecated and/or outdated.

Finally, a word-aligned atomic write that updates, in the file table, a version of a block representing the first directory with the incremented version is performed (operation 508). For example, the write may update an entry for the block in the file table with the incremented version, thereby indicating that the first directory has been modified and/or replaced.

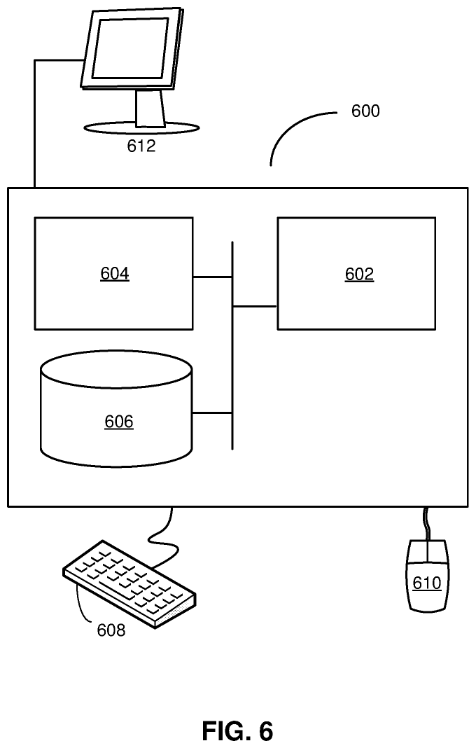

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for managing inter-process communication. The system includes a block storage manager for managing shared memory that is accessed by a write process and multiple read processes. The block storage manager manages one or more data structures storing mappings that include block identifiers (IDs) of blocks representing chunks of the shared memory, files in the blocks, and directories containing the files. The block storage manager also applies an update by the write process to a subset of the blocks by atomically replacing, in the one or more data structures, a first directory containing an old version of the subset of the blocks with a second directory containing a new version of the subset of the blocks.

In addition, one or more components of computer system 600 may be remotely located and connected to the other components over a network. Portions of the present embodiments (e.g., source of truth, graph database, block storage manager, etc.) may also be located on different nodes of a distributed system that implements the embodiments. For example, the present embodiments may be implemented using a cloud computing system that manages access to a pool of shared memory by a set of remote processes.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
executing, by a computer system, a block storage manager for managing shared memory that is accessed by a write process and multiple read processes;
managing, by the block storage manager, one or more data structures storing mappings comprising block identifiers (IDs) of blocks representing chunks of the shared memory, files in the blocks, and directories containing the files; and
applying, by the block storage manager, an update by the write process to a subset of the blocks by atomically replacing, in the one or more data structures, a first directory comprising an old version of the subset of the blocks with a second directory comprising a new version of the subset of the blocks.

2. The method of claim 1, further comprising:
creating, by the block storage manager, the second directory and the new version of the subset of the blocks in response to one or more requests from the write process.

3. The method of claim 2, wherein creating the second directory comprises:
adding, to the blocks, a directory block representing the second directory; and
creating the second directory within a filesystem on the computer system.

4. The method of claim 2, wherein creating the new version of the subset of the blocks comprises:
updating the one or more data structures with a first block ID of the new version of a block, a filename of a file in the block, and a second block ID of the second directory.

5. The method of claim 1, further comprising:
creating the old version of the subset of the blocks in response to one or more requests from the write process; and
mapping one or more files in the subset of the blocks into a virtual address space of one or more processes requesting opening of the one or more files.

6. The method of claim 1, further comprising:
resizing a block in response to a request from the write process; and
mapping the resized block into a virtual address space of one or more processes requesting remapping of the block.

7. The method of claim 1, further comprising:
in response to a request from a read process to reopen the first directory:
providing the second directory to the read process; and
mapping the new version of the subset of the blocks into a virtual address space of the read process.

8. The method of claim 1, wherein the blocks comprise:
a graph database storing a graph, wherein the graph comprises a set of nodes, a set of edges between pairs of nodes in the set of nodes, and a set of predicates; and
an index comprising:
a hash map storing offsets into an edge store for the graph database; and
the edge store storing edges that match one or more keys in the hash map.

9. The method of claim 8, wherein the first directory comprises the old version of the hash map and the edge store and the second directory comprises the new version of the hash map and the edge store.

10. The method of claim 1, wherein the one or more data structures comprise:
a name table storing names of the files and the directories; and
a file table storing the block IDs of the blocks, versions of the blocks, offsets into the name table, and the directories containing the blocks.

11. The method of claim 10, wherein atomically replacing, in the one or more data structures, the first directory comprising the old version of the subset of the blocks with the second directory comprising the new version of the subset of the blocks comprises:
renaming the second directory to a name of the first directory with an incremented version for the first directory;
updating file paths of the new version of the subset of the blocks to include the name of the first directory and the incremented version; and
performing a word-aligned atomic write that updates, in the file table, a version of a block representing the first directory with the incremented version.

12. The method of claim 11, wherein atomically replacing, in the one or more data structures, the first directory comprising the old version of the subset of the blocks with the second directory comprising the new version of the subset of the blocks further comprises:
updating, in the file table, versions of the second directory and the old version of the subset of the blocks to indicate the replacement of the first directory and the old version of the subset of the blocks.

13. A system, comprising:
one or more processors; and
memory storing instructions that, when executed by the one or more processors, cause the system to:
execute a block storage manager for managing shared memory that is accessed by a write process and multiple read processes;
manage, by the block storage manager, one or more data structures storing mappings comprising block identifiers (IDs) of blocks representing chunks of the shared memory, files in the blocks, and directories containing the files; and
apply, by the block storage manager, an update by the write process to a subset of the blocks by atomically replacing, in the one or more data structures, a first directory comprising an old version of the subset of the blocks with a second directory comprising a new version of the subset of the blocks.

14. The system of claim 13, wherein the memory further stores instructions that, when executed by the one or more processors, cause the system to:
create, by the block storage manager, the second directory and the new version of the subset of the blocks in response to one or more requests from the write process.

15. The system of claim 14, wherein creating the second directory comprises:
adding, to the blocks, a directory block representing the second directory; and
creating the second directory within a filesystem on the computer system.

16. The system of claim 14, wherein creating the new version of the subset of the blocks comprises:
updating the one or more data structures with a first block ID of the new version of a block, a filename of a file in the block, and a second block ID of the second directory.

17. The system of claim 13, wherein the one or more data structures comprises:
a name table storing names of the files and the directories; and
a file table storing the block IDs of the blocks, versions of the blocks, offsets into the name table, and the directories containing the blocks.

18. The system of claim 13, wherein atomically replacing, in the one or more data structures, the first directory comprising the old version of the subset of the blocks with the second directory comprising the new version of the subset of the blocks comprises:
renaming the second directory to a name of the first directory with an incremented version for the first directory;
updating file paths of the new version of the subset of the blocks to include the name of the first directory and the incremented version; and
performing a word-aligned atomic write that updates, in the file table, a version of a block representing the first directory with the incremented version.

19. A non-transitory computer-readable storage medium storing instructions that when executed by a computer cause the computer to perform a method, the method comprising:
executing a block storage manager for managing shared memory that is accessed by a write process and multiple read processes;
managing, by the block storage manager, one or more data structures storing mappings comprising block identifiers (IDs) of blocks representing chunks of the shared memory, files in the blocks, and directories containing the files; and
applying, by the block storage manager, an update by the write process to a subset of the blocks by atomically replacing, in the one or more data structures, a first directory comprising an old version of the subset of the blocks with a second directory comprising a new version of the subset of the blocks.

20. The non-transitory computer-readable storage medium of claim 19, wherein the blocks comprise:
a graph database storing a graph, wherein the graph comprises a set of nodes, a set of edges between pairs of nodes in the set of nodes, and a set of predicates; and
an index comprising:
a hash map storing offsets into an edge store for the graph database; and
the edge store storing edges that match one or more keys in the hash map,
wherein the first directory comprises the old version of the hash map and the edge store and the second directory comprises the new version of the hash map and the edge store.
